(19) United States
(12) Patent Application Publication
(10) Pub. No.: US 2022/0215660 A1
(43) Pub. Date: Jul. 7, 2022

(54) SYSTEMS, METHODS, AND MEDIA FOR ACTION RECOGNITION AND CLASSIFICATION VIA ARTIFICIAL REALITY SYSTEMS

(71) Applicant: Facebook Technologies, LLC, Menlo Park, CA (US)

(72) Inventors: Miao Liu, McLean, VA (US); Chao Li, Woodinville, WA (US); Kiran Kumar Somasundaram, Bellevue, WA (US)

(21) Appl. No.: 17/502,438

(22) Filed: Oct. 15, 2021

Related U.S. Application Data
(60) Provisional application No. 63/133,740, filed on Jan. 4, 2021.

(51) Int. Cl. G06V 20/20; G06V 20/64; G06T 19/00; H04L 67/01

(52) U.S. Cl. CPC G06V 20/20; G06V 20/64; G06V 2201/10; H04L 67/42; G06T 19/006

(57) ABSTRACT

In particular embodiments, a computing system may determine a user intent to perform a task in a physical environment surrounding the user. The system may send a query based on the user intent to a mapping server that stores a three-dimensional (3D) occupancy map containing spatial and semantic information of physical items in the physical environment. The mapping server may be configured to identify a subset of the physical items that are relevant to the user intent. The system may receive, from the mapping server, a response to the query comprising a portion of the 3D occupancy containing the subset of the physical items specific to the user intent. The system may capture a plurality of video frames of the physical environment. The system may process the plurality of video frames and the portion of the 3D occupancy map to provide one or more action labels associated with the task.

### PRIORITY

This application claims the benefit, under 35 U.S.C. § 119(e), of U.S. Provisional Patent Application No. 63/133,740, filed 4 Jan. 2021, which is incorporated herein by reference.

### TECHNICAL FIELD

This disclosure generally relates to action recognition and classification. In particular, the disclosure relates to action region detection and action label classification for performing action direction tasks via artificial reality systems.

### BACKGROUND

Egocentric vision has been the subject of many recent studies, because of the potential application in robotics, and new trend of human-computer interaction (e.g., augmented reality). Tremendous progress has been made in understanding the egocentric activity captured by temporal sequence of two-dimensional (2D) image frames, yet humans live in a three-dimensional (3D) world and the 3D environment factor has largely been ignored in these studies. There is rich set of literature aiming at understanding human activity from egocentric perspective. Existing works have made great progress on recognizing and anticipating human-object interaction, predicting gaze and locomotion, however none considered the role of 3D environment factor and egocentric activity spatial grounding. Also, none of the previous or existing works explicitly model the semantic meaning of the environment. More importantly, the 3D spatial structure information of the environment has been ignored by the existing works. Furthermore, there is currently no effective way of integrating sensory data with 3D understanding of physical environments. A collective 3D environment representation that encodes information of both action location and semantic context remains unexplored.

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Artificial reality may be associated with applications, products, accessories, services, or some combination thereof, that are, e.g., used to create content in artificial reality and/or used in (e.g., perform activities in) an artificial reality. Artificial reality systems that provide artificial reality content may be implemented on various platforms, including a head-mounted device (HMD) connected to a host computer system, a standalone HMD, a mobile device or computing system, or any other hardware platform capable of providing artificial reality content to one or more viewers.

Augmented reality (AR) devices, such as AR glasses or headsets, are generally resource-constrained devices with limited memory and processing capabilities. When a user is wearing an AR device and roaming around in an environment, there may be numerous objects around and a large number of tasks/actions corresponding to these objects that may be possible to be performed in the environment. Processing such large action space in order to recommend actions to the user is inefficient and beyond the general computing capabilities of the AR device. As such, there is a need to reduce down this action space and to display condensed information to the user in real time that is relevant as per the user's current intent/context and their surrounding environment.

### SUMMARY OF PARTICULAR EMBODIMENTS

Embodiments described herein relate to a service provided by a mapping server containing 3D maps of objects in the real world that helps AR systems/devices to efficiently recognize actions performed by users (e.g., watching TV, cooking, etc.) and provide appropriate action labels to perform tasks (e.g., action direction tasks). As users move around in a physical space (e.g., apartment), 3D map(s) get updated with 3D spatial information in that space (e.g., items in a pantry, location of the couch, the on/off state of a TV, etc.). A compressed 3D occupancy map containing spatial and semantic information of physical items that are relevant to a user intent in the user's current physical environment may be provided to AR devices to help with action direction tasks. The set of tasks that are ultimately recognized by an AR device based on such compressed 3D occupancy map is much smaller than a general list of tasks that are possible in their surrounding space. As such, the set of tasks becomes constrained and therefore it becomes easier for the artificial intelligence (AI) running on the AR device to efficiently aid in the action direction tasks. Also, the action labels that are provided for performing these action directions tasks may be personalized for different users. For instance, if two users are in the kitchen baking a cake, then the action labels provided to each user might be different from the other. As an example, user A might bake the cake in a particular way while user B bakes the cake in a different way, and the AR device for each user may provide different cake baking steps/directions as per the user's history even though they might be located in the same physical space.

In particular embodiments, the above is achieved through a client-server architecture, where the client is an AR system (e.g., an AR glass) and the server is a mapping server containing 3D maps of objects. The mapping server may be located in the user's home, such as a central hub/node. The AR system may be responsible for identifying a user's intent or context (e.g., watching TV, cooking, etc.) and passing this intent to the mapping server for a reduced action space. In one embodiment, the user's intent may be explicitly provided through an auditory context (e.g., verbal/speech command). By way of an example, the user wearing his AR glass might say “Hey, I want to bake a cake”. In other embodiments, the intent can be provided in other ways including, implicit detection via user's current viewpoint, motion, machine learning, etc. Once the user intent is identified, it is sent to the mapping server for further processing. The mapping server, using the received user intent, may provide a compressed representation of the 3D environment in the form of a parent-children semantic occupancy map to the AR system. The parent-children semantic occupancy map is a compact representation that encompasses the action region candidates, 3D spatial structure information, and semantic meaning of the scanned environment all together under a single format. The AR system may use the parent-children semantic occupancy map to detect relevant action region(s) and accordingly provide action label(s) for performing action direction tasks (e.g., steps on baking a cake, doing laundry, washing utensils, etc.) on the AR device, such as the AR glass.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example artificial reality system worn by a user, in accordance with particular embodiments.

FIG. 1B illustrates example components of an artificial reality system for action region detection and action label classification, in accordance with particular embodiments.

FIG. 2 illustrates example components of a mapping server, in accordance with particular embodiments.

FIG. 3 illustrates an example interaction flow diagram between a mapping server and an artificial reality system, in accordance with particular embodiments.

FIG. 4A illustrates an example physical environment viewable by a user through an artificial reality system and an example user intent received by a mapping server from the artificial reality system, in accordance with particular embodiments.

FIG. 4B illustrates an example parent-children semantic occupancy map of a physical environment produced by a mapping server based on the user intent received from the artificial reality system in FIG. 4A, in accordance with particular embodiments.

FIG. 4C illustrates an example action region detection by the artificial reality system based on the 3D occupancy map received from the mapping server in FIG. 4B, in accordance with particular embodiments.

FIGS. 4D-4E illustrate example actions labels provided by an artificial reality system for performing a task based on the action region detected in FIG. 4C, in accordance with particular embodiments.

FIG. 5 illustrates an example method for providing one or more action labels associated with a task, in accordance with particular embodiments.

FIG. 6 illustrates an example network environment associated with an AR/VR or social-networking system.

FIG. 7 illustrates an example computer system.

### DESCRIPTION OF EXAMPLE EMBODIMENTS

Augmented reality (AR) devices, such as AR glasses or headsets, are generally resource-constrained devices with limited memory and processing capabilities. When a user is wearing an AR device and roaming around in an environment, there may be numerous objects around and a large number of tasks/actions corresponding to these objects that may be possible to be performed in the environment. Processing such large action space in order to recommend actions to the user is inefficient and beyond the general computing capabilities of the AR device. As such, there is a need to reduce down this action space and to display condensed information to the user in real time that is relevant as per the user's current intent/context and their surrounding environment.

Embodiments described herein relate to a service provided by a mapping server containing 3D maps of objects in the real world that helps AR systems/devices to efficiently recognize actions performed by users (e.g., watching TV, cooking, etc.) and provide appropriate action labels to perform tasks (e.g., action direction tasks). As users move around in a physical space (e.g., apartment), 3D map(s) get updated with 3D spatial information in that space (e.g., items in a pantry, location of the couch, the on/off state of a TV, etc.). A compressed 3D occupancy map containing spatial and semantic information of physical items that are relevant to a user intent in the user's current physical environment may be provided to AR devices to help with action direction tasks. The set of tasks that are ultimately recognized by an AR device based on such compressed 3D occupancy map is much smaller than a general list of tasks that are possible in their surrounding space. As such, the set of tasks becomes constrained and therefore it becomes easier for the AI running on the AR device to efficiently aid in the action direction tasks. Also, the action labels that are provided for performing these action directions tasks may be personalized for different users. For instance, if two users are in the kitchen baking a cake, then the action labels provided to each user might be different from the other. As an example, user A might bake the cake in a particular way while user B bakes the cake in a different way, and the AR device for each user may provide different cake baking steps/directions as per the user's history even though they might be located in the same physical space.

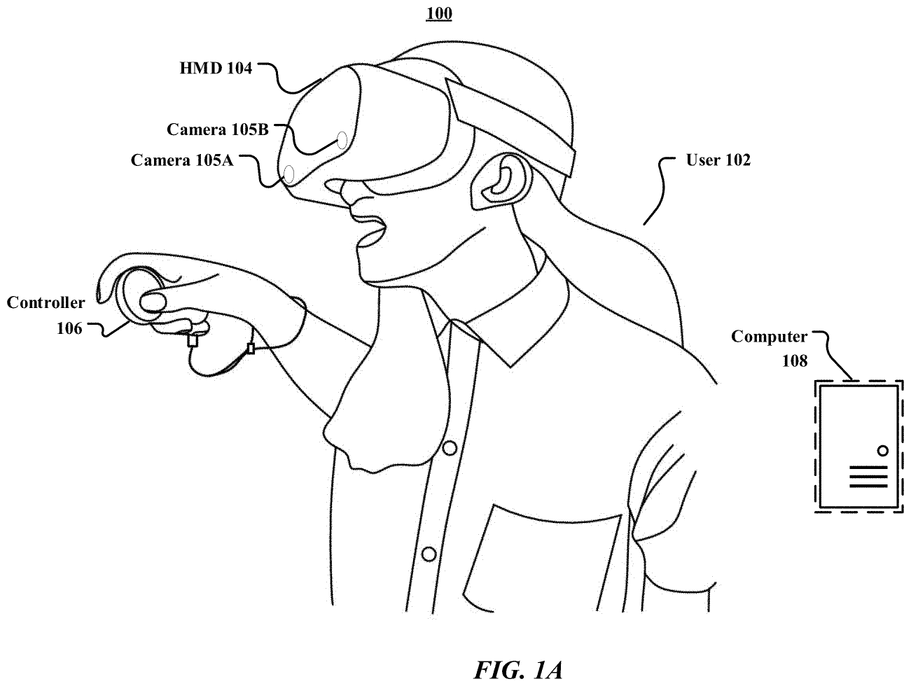

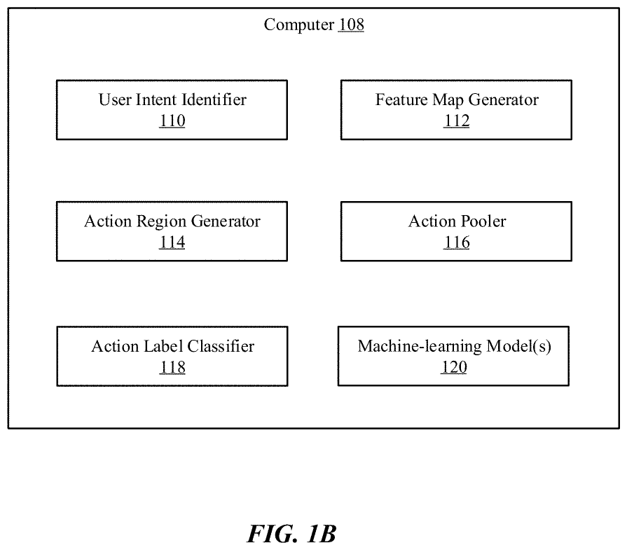

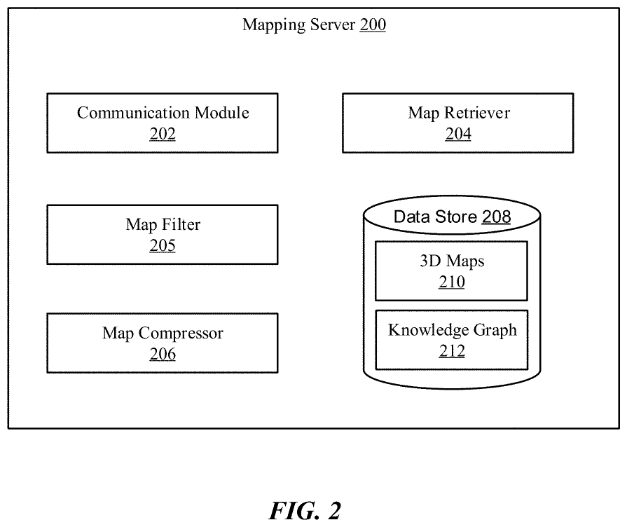

In particular embodiments, the above is achieved through a client-server architecture, where the client is an AR system (e.g., an AR glass) and the server is a mapping server containing 3D maps of objects. In particular embodiments, the AR system or the AR glass discussed herein is an AR system 100 as shown and discussed in reference to at least FIGS. 1A-1B. In particular embodiments, the mapping server discussed herein is a mapping server 200 as shown and discussed in reference to at least FIG. 2. The mapping server may be located in the user's home, such as a central hub/node. The AR system may be responsible for identifying a user's intent or context (e.g., watching TV, cooking, etc.) and passing this intent to the mapping server for a reduced action space. In one embodiment, the user's intent may be explicitly provided through an auditory context (e.g., verbal/speech command). By way of an example, the user wearing his AR glass might say “Hey, I want to bake a cake”. In other embodiments, the intent can be provided in other ways including, implicit detection via user's current viewpoint, motion, machine learning, etc. Once the user intent is identified, it is sent to the mapping server for further processing. The mapping server, using the received user intent, may provide a compressed representation of the 3D environment in the form of a parent-children semantic occupancy map to the AR system. The parent-children semantic occupancy map is a compact representation that encompasses the action region candidates, 3D spatial structure information, and semantic meaning of the scanned environment all together under a single format. The AR system may use the parent-children semantic occupancy map to detect relevant action region(s) and accordingly provide action label(s) for performing action direction tasks (e.g., steps on baking a cake, doing laundry, washing utensils, etc.) on the AR device, such as the AR glass. The AR system, the mapping server, and/or the client-server architecture are further discussed below in reference to at least FIGS. 1A-1B, 2, and 3.

FIG. 1A illustrates an example of an artificial reality system 100 worn by a user 102. In particular embodiments, the artificial reality system 100 may comprise a head-mounted device (“HMD”) 104, a controller 106, and a computing system 108. The HMD 104 may be worn over the user's eyes and provide visual content to the user 102 through internal displays (not shown). The HMD 104 may have two separate internal displays, one for each eye of the user 102. As illustrated in FIG. 1A, the HMD 104 may completely cover the user's field of view. By being the exclusive provider of visual information to the user 102, the HMD 104 achieves the goal of providing an immersive artificial-reality experience.

The HMD 104 may have external-facing cameras, such as the two forward-facing cameras 105A and 105B shown in FIG. 1A. While only two forward-facing cameras 105A-B are shown, the HMD 104 may have any number of cameras facing any direction (e.g., an upward-facing camera to capture the ceiling or room lighting, a downward-facing camera to capture a portion of the user's face and/or body, a backward-facing camera to capture a portion of what's behind the user, and/or an internal camera for capturing the user's eye gaze for eye-tracking purposes). The external-facing cameras are configured to capture the physical environment around the user and may do so continuously to generate a sequence of frames (e.g., as a video).

The 3D representation may be generated based on depth measurements of physical objects observed by the cameras 105A-B. Depth may be measured in a variety of ways. In particular embodiments, depth may be computed based on stereo images. For example, the two forward-facing cameras 105A-B may share an overlapping field of view and be configured to capture images simultaneously. As a result, the same physical object may be captured by both cameras 105A-B at the same time. For example, a particular feature of an object may appear at one pixel p_{A} in the image captured by camera 105A, and the same feature may appear at another pixel p_{B} in the image captured by camera 105B. As long as the depth measurement system knows that the two pixels correspond to the same feature, it could use triangulation techniques to compute the depth of the observed feature. For example, based on the camera 105A's position within a 3D space and the pixel location of p_{A} relative to the camera 105A's field of view, a line could be projected from the camera 105A and through the pixel p_{A}. A similar line could be projected from the other camera 105B and through the pixel p_{B}. Since both pixels are supposed to correspond to the same physical feature, the two lines should intersect. The two intersecting lines and an imaginary line drawn between the two cameras 105A and 105B form a triangle, which could be used to compute the distance of the observed feature from either camera 105A or 105B or a point in space where the observed feature is located.

In particular embodiments, the pose (e.g., position and orientation) of the HMD 104 within the environment may be needed. For example, in order to render the appropriate display for the user 102 while he is moving about in a virtual environment, the system 100 would need to determine his position and orientation at any moment. Based on the pose of the HMD, the system 100 may further determine the viewpoint of either of the cameras 105A and 105B or either of the user's eyes. In particular embodiments, the HMD 104 may be equipped with inertial-measurement units (“IMU”). The data generated by the IMU, along with the stereo imagery captured by the external-facing cameras 105A-B, allow the system 100 to compute the pose of the HMD 104 using, for example, SLAM (simultaneous localization and mapping) or other suitable techniques.

In particular embodiments, the artificial reality system 100 may further have one or more controllers 106 that enable the user 102 to provide inputs. The controller 106 may communicate with the HMD 104 or a separate computing unit 108 via a wireless or wired connection. The controller 106 may have any number of buttons or other mechanical input mechanisms. In addition, the controller 106 may have an IMU so that the position of the controller 106 may be tracked. The controller 106 may further be tracked based on predetermined patterns on the controller. For example, the controller 106 may have several infrared LEDs or other known observable features that collectively form a predetermined pattern. Using a sensor or camera, the system 100 may be able to capture an image of the predetermined pattern on the controller. Based on the observed orientation of those patterns, the system may compute the controller's position and orientation relative to the sensor or camera.

The artificial reality system 100 may further include a computer unit 108. The computer unit may be a stand-alone unit that is physically separate from the HMD 104 or it may be integrated with the HMD 104. In embodiments where the computer 108 is a separate unit, it may be communicatively coupled to the HMD 104 via a wireless or wired link. The computer 108 may be a high-performance device, such as a desktop or laptop, or a resource-limited device, such as a mobile phone. A high-performance device may have a dedicated GPU and a high-capacity or constant power source. A resource-limited device, on the other hand, may not have a GPU and may have limited battery capacity. As such, the algorithms that could be practically used by an artificial reality system 100 depends on the capabilities of its computer unit 108.

FIG. 1B illustrates example components of the artificial reality system 100. In particular, FIG. 1B shows components that are part of the computer 108 of the artificial reality system 100. As depicted, the computer 108 may include a user intent identifier 110, a feature map generator 112, an action region generator 114, an attention pooler 116, an action label classifier 118, and one or more machine-learning models 120. These components 110, 112, 114, 116, 118, and/or 120 may cooperate with each other and with one or more components 202, 204, 205, 206, or 208 of the mapping server 200 to perform the operations of action region detection and action label classification discussed herein.

The user intent identifier 110 may be configured to identify a user intent or context for performing a task (e.g., an action direction task). In one embodiment, the user intent or context may be provided explicitly through a voice command of the user and the user intent identifier 110 may work with sensors (e.g., a voice sensor) of the artificial-reality system 100 to identify or figure out the user intent. In other embodiments, the user intent identifier 110 may identify a user intent implicitly (i.e., automatically and without explicit user input) based on certain criteria. For instance, the criteria may include a time of day, user's current location, and user's previous history, and the user intent identifier 110 may use these criteria to automatically identify the user intent without explicit user input. In yet other embodiments, the user intent identifier 110 may identify a user intent based on user's current viewpoint. For instance, if the user is currently looking at the microwave, then based on user's history and a time of day, the user intent identifier 110 may identify that the user intent is to make popcorn using the microwave. In some embodiments, the user intent identifier 110 may be trained to implicitly/automatically identify a user intent. For instance, one or more machine-learning models 120 may be trained and the user intent identifier 110 may use these trained models 120 to identify the user intent. It should be understood that the user intent identifier 110 is not limited to just these ways of identifying a user intent and other ways are also possible and within the scope of the present disclosure. Once a user intent or context has been identified, the user intent identifier 110 may further be configured to send the identified intent/context to a mapping server, such as the mapping server 200 to perform its operations thereon.

The feature map generator 112 may be configured to generate a feature map. In particular embodiments, the feature map generator 112 may be configured to generate a feature map corresponding to a compressed representation of the 3D environment (e.g., 3D occupancy map or parent-children semantic occupancy map) received from a mapping server, such as the mapping server 200. The feature map generator 112 may also be configured to generate a second feature map corresponding to one or more video frames that may be captured by cameras 105A-105B of the artificial-reality system 100. In particular embodiments, the feature map generator 112 may use a three-dimensional (3D) convolution network to generate the feature maps discussed herein. For instance, the feature map generator 112 may take a portion of the 3D occupancy map (parent-children semantic occupancy map) as input and uses 3D convolutional network to extract global 3D spatial environment feature. Similarly, the feature map generator 112 may take video frames as input and utilizes 3D convolutional network to extract spatial-temporal video feature. Once the feature map(s) are generated, the feature map generator 112 may further be configured to send the generated feature map(s) to the action region generator 114 for it to perform its corresponding operations thereon.

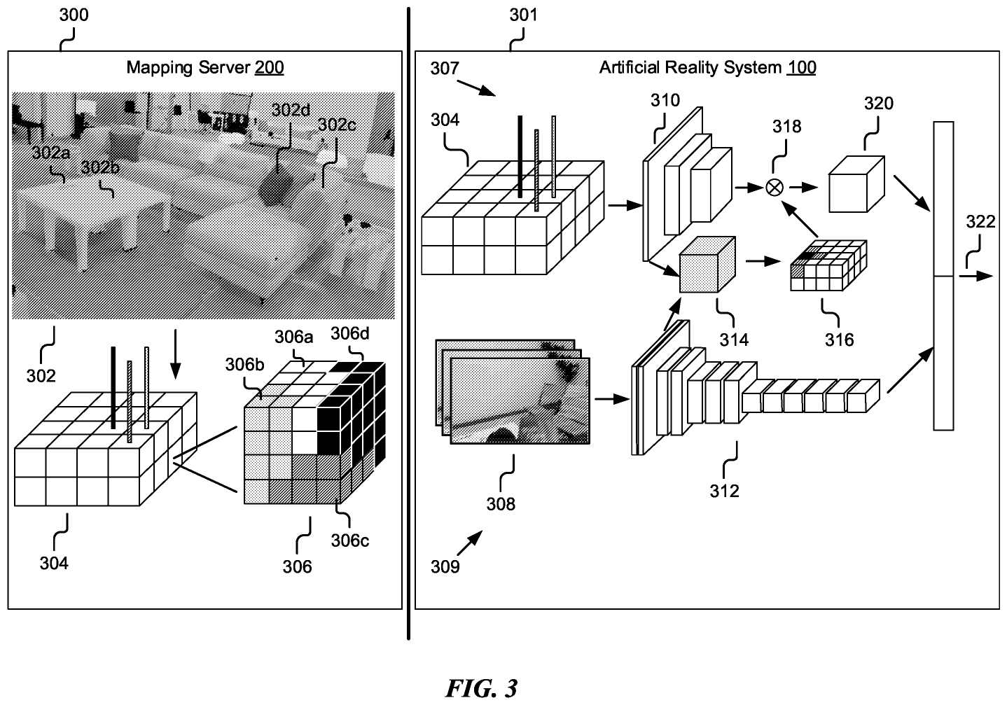

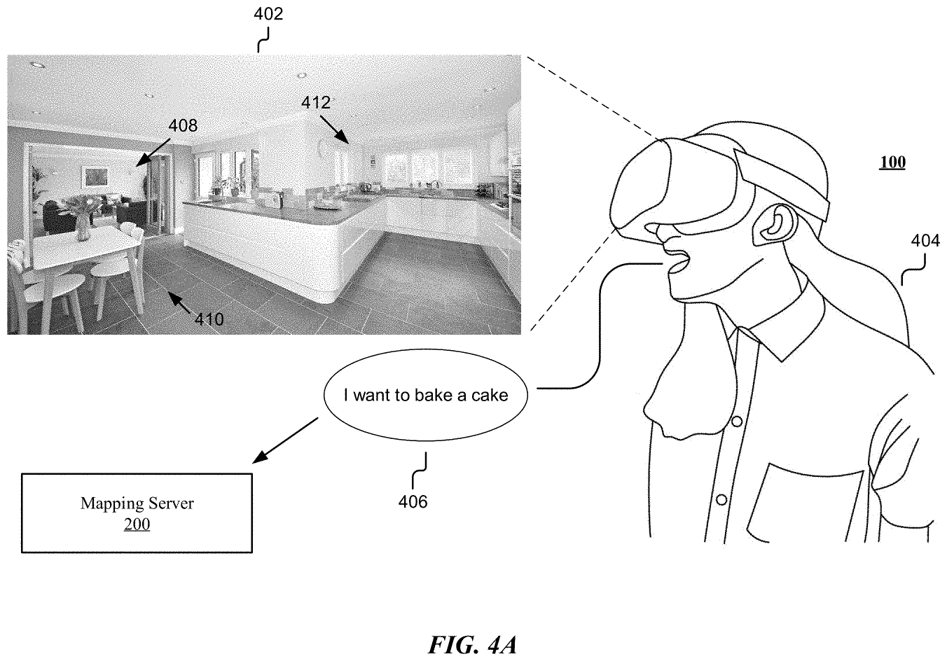

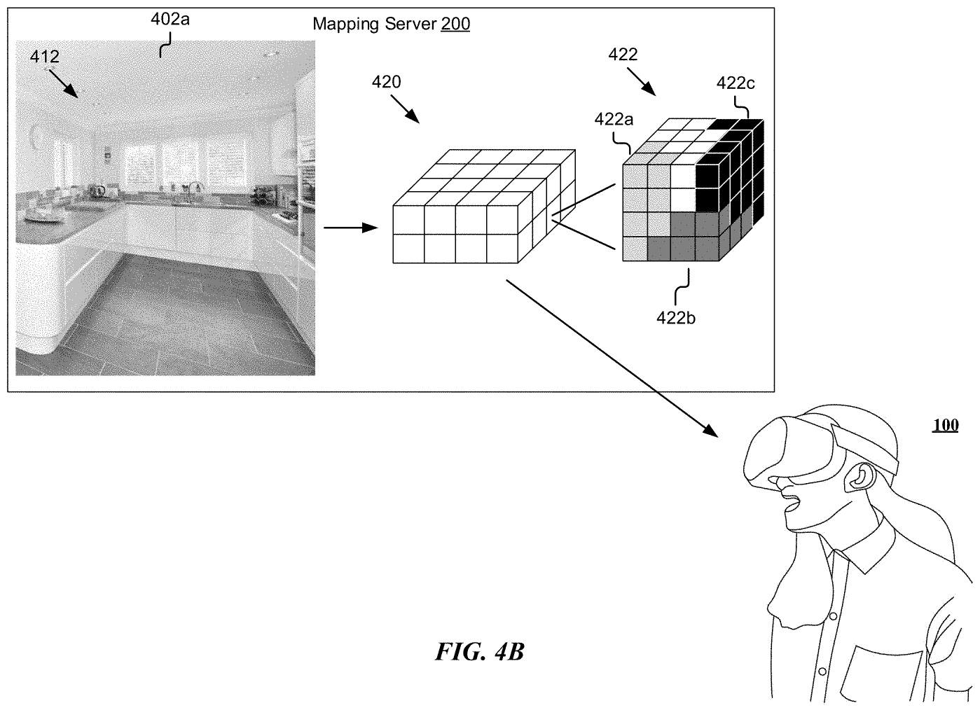

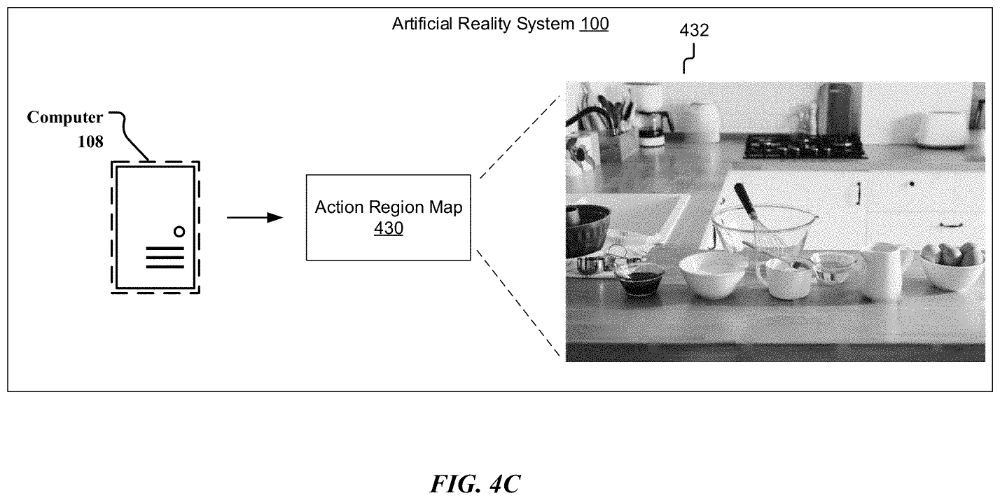

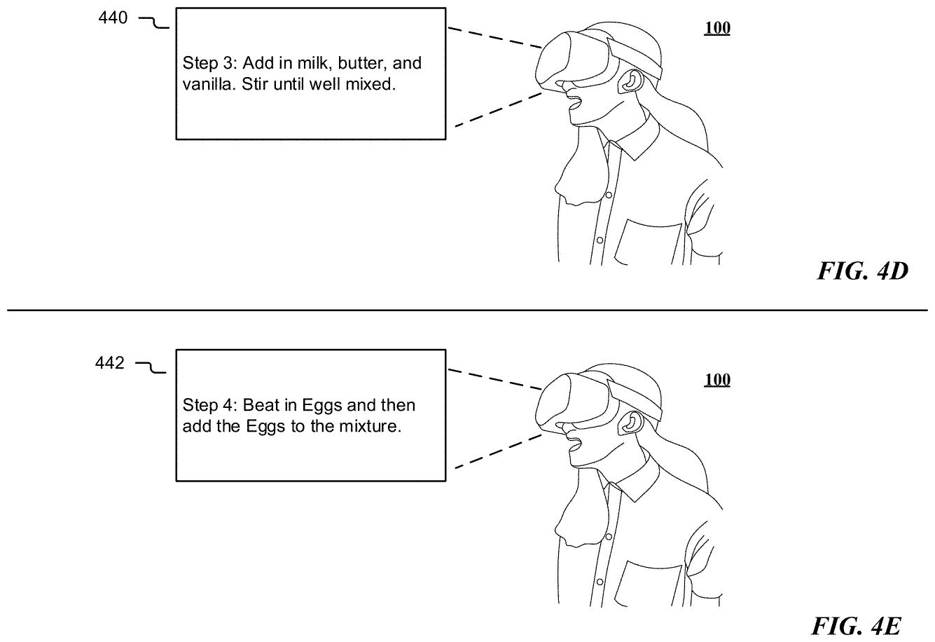

The action region generator 114 may be configured to generate an action region map. The action region map may be a heat map that highlights locations or indicate probabilities of where action is likely to happen, as discussed in further detail below in reference to at least FIGS. 3 and 4C. In particular embodiments, the action region generator 114 may use the feature maps (e.g., global 3D spatial environment feature and spatial-temporal video feature) received from the feature map generator 112 to generate an action region map. For instance, the action region generator 114 may concatenate a first feature map corresponding to a compressed 3D occupancy map received from a mapping server (e.g., the mapping server 200) and a second feature map corresponding to one or more video frames of the user's current physical environment to generate an action region map, such as an action region map 316, as shown and discussed in reference to FIG. 3. In some embodiments, the action region generator 114 may use a machine-learning model (e.g., machine-learning model 120) to generate the action region or heat map, as discussed elsewhere herein.

The attention pooler 116 may be configured to identify environment regions or features of interest. In particular embodiments, the attention pooler 116 may use the feature map corresponding to the parent-children semantic occupancy map (e.g., parent voxel) and the action region map generated from the action region generator 114 to tell to the system specific regions, where the system or the network should pay its attention to. In some embodiments, after going the attention pooling process, the attention pooler may generate a filtered feature map (e.g., feature map 320) corresponding to the compressed map representation.

The action label classifier 118 may be configured to generate one or more action labels based on action recognition. The one or more action labels may aid in performing one or more action direction tasks associated with the user intent that is identified by the user intent identifier 110. By way of a non-limiting example, if the user intent is to bake a cake, the one or more action labels may include steps that are needed to bake the cake, as shown for example in FIGS. 4D-4E. In particular embodiments, the action label classifier 118 may use the filtered feature map generated by the attention pooler 116 and the feature map corresponding to the video frame(s) generated by the feature map generator 112 to generate the one or more action labels. For instance, as shown in reference to FIG. 3, the action label classifier 118 may use the filtered feature map 320 and the feature map 312 to generate action labels 322. The action label classifier 118 may overlay the generated action labels on a display screen of the artificial reality system 100.

In some embodiments, the action label classifier may use a trained machine-learning model (e.g., machine-learning model 120) to generate the one or more action labels. For instance, a machine-learning model 120 may be trained based on each user's preference or history of their past actions, and the action label classifier 118 may use the trained machine-learning model 120 to personalize the action labels for each user. For instance, in the cake baking example, action labels including steps to bake the cake for a first user may be different from steps generated for a second user. The action labels may be personalized based on a user's preference, history, etc. For instance, the first user may like to bake the cake in a way that is different from the second user and the action label classifier 118 may provide the action labels accordingly.

Additional description of the user intent identifier 110, the feature map generator 112, the action region generator 114, the attention pooler 116, the action label classifier 118, and/or the one or more machine-learning models 120 may be found below in reference to at least FIGS. 3, 4A-4E, and 5.

FIG. 2 illustrates example components of a mapping server 200. At a high level, the mapping server 200 may be responsible for action space reduction (e.g., reducing a list of actions that are possible in the user's physical environment) and/or 3D map compression (e.g., compressing and providing a compressed representation of the 3D environment to the artificial reality system 100). As depicted, the mapping server 200 may include a communication module 202, a map retriever 204, a map filter 205, a map compressor 206, and a data store 208 including 3D maps 210 and a knowledge graph 212. These components 202, 204, 205, 206, and 208 may cooperate with each other and with one or more components 110, 112, 114, 116, 118, or 120 of the artificial reality system 100 to perform the operations of action space reduction and/or 3D map compression discussed herein.

The communication module 202 may be configured to send and/or receive data to and/or from the artificial reality system 100. In particular embodiments, the communication module 202 may be configured to send data received from the artificial reality system 100 to one or more other components 204, 205, or 206 of the mapping server 200 for performing their respective operations thereon. For instance, the communication module 202 may receive a user intent from the user intent identifier 110 and send the received user intent to the map retriever 204 for it to retrieve a corresponding map of the physical environment, as discussed in further detail below. In particular embodiments, the communication module 202 may further be configured to send data processed by the mapping server 200 back to the artificial reality system 100 for performing its respective operations thereon. For instance, the communication module 202 may receive a portion of the 3D occupancy map or a parent-children semantic occupancy map from the map compressor 206 and send it to the computer 108 of the artificial reality system 100 for it to perform the operations of action region detection and action label classification discussed herein.

The map retriever 204 may be configured to retrieve a map from the data store 208 based on data received from the artificial reality system 100. For instance, the map retriever 204 may receive one or more of a user intent, a time of day, user's current location, or user's history/preferences from the artificial reality system 100, and use one or more of these to retrieve a map of the user's physical environment. In particular embodiments, a plurality of maps/3D maps 210 may be stored in the data store 208 and the map retriever 204 may retrieve the map corresponding to the user's intent from the data store 208.

The map filter 205 may be configured to filter the map retrieved by the map retriever 204. In particular embodiments, the map filter 205 may filter the map based on identifying a set of items that are relevant to the received user's intent/context and then filtering out objects from the map that are not relevant to the user's intent/context. For instance, the map filter 205 may use a knowledge graph 212 (also interchangeably herein referred to as a scene graph) to identify the relevant set of items. The knowledge graph 212 may define relationships between objects or a set of items. For instance, the knowledge graph 212 may define, for each item, a set of items that are commonly associated with that item. By way of an example, the knowledge graph 212 may identify eggs, milk, sugar, oven, chocolate powder, baking pan, baking sheet, mixing bowl, utensils, etc. as some of the items that are commonly associated when baking a cake. Using the identified set of items, the map filter 205 may filter out the items that are not associated with the user's context from the retrieved map, as shown and further discussed in reference to FIG. 4B. The map filter 205 may send a filtered map (e.g., a portion of the 3D map) to the map compressor 206 for it perform its respective operations thereon.

The map compressor 206 may be configured to compress the map and send a compressed representation of the map to the artificial reality system 100. In particular embodiments, the map compressor 206 may receive the filtered map along with the set of relevant items (e.g., identified using knowledge graph 212) from the map filter 205. The map compressor 206 may convert the filtered map into a parent-children semantic occupancy map in voxel format (e.g., voxel format 304 as shown in FIG. 3) and indexes the relevant set of items within the voxel format. The voxel format may be a high-level representation of the filtered map. In particular embodiments, the voxel format is a parent voxel that includes a plurality of children voxels, as shown and further discussed in reference to at least FIGS. 3 and 4B. Each of the children voxels may be made up of a set of grids/vertices that indicate a rough/coarse location or feature(s) of an item of the relevant set of items, as identified using the knowledge graph 212. The map compressor 206 may send the compressed representation of the 3D occupancy map (e.g., parent-children semantic occupancy map) to the communication module 202, which may eventually send it to the computer 108 of the artificial reality system 100 for it to perform the operations of action region detection and action label classification discussed herein.

The data store 208 may be used to store various types of information. In particular embodiments, the data store 208 may store 3D maps 210 and the knowledge graph 212, as discussed elsewhere herein. In particular embodiments, the information stored in data store 208 may be organized according to specific data structures. In particular embodiments, the store 208 may be a relational, columnar, correlation, or other suitable database. Although this disclosure describes or illustrates particular type of database, this disclosure contemplates any suitable types of databases. Particular embodiments may provide interfaces that enable the artificial reality system 100, the mapping server 200, or a third-party system (e.g., a third-party system 670) to manage, retrieve, modify, add, or delete, the information stored in data store 208.

In particular embodiments, a 3D map 210 may be a 3D occupancy map that contains spatial and semantic information of physical items in a physical environment surrounding a user. In some embodiments, the 3D map 210 is a high-resolution global map of the physical environment surrounding the user. In particular embodiments, 3D maps 210 get updated with 3D spatial information as users move around in a physical space (e.g., in their apartment). For example, a 3D map 210 may be updated to include items in a pantry, location of a couch, on/off state of a TV, etc.

In particular embodiments, the knowledge graph 212 (also referred to interchangeably as a scene graph) may define relationships between objects or a set of items. For instance, the knowledge graph 212 may define, for each item, a set of items that are commonly associated with that item. By way of an example, the knowledge graph 212 may identify eggs, milk, sugar, oven, chocolate powder, baking pan, baking sheet, mixing bowl, utensils, etc. as some of the items that are commonly associated with a cake.

Additional description of the communication module 202, the map retriever 204, the map filter 205, the map compressor 206, and the data store 208 (including the 3D maps 210 and the knowledge graph 212) may be found below in reference to at least FIGS. 3, 4A-4E, and 5.

FIG. 3 illustrates an example interaction flow diagram between a mapping server 200 and an artificial reality system 100, in accordance with particular embodiments. At a high level, given an input egocentric video (e.g., indicated by reference numeral 308) denoted as x=(x¹, . . . , x^{t}) with its frames x^{t} indexed by time t, and an 3D environment prior e (e.g., indicated by reference numeral 304) that may be available at both training and inference time, the goal is to jointly predict an action category y of x and a corresponding action region r (e.g., indicated by reference numeral 314) in 3D environment. Since human action is usually grounded on the 3D environment, the temporal dimension of action region may be omitted and the action region r may be shared across the entire action clip x. The action region r may be parameterized as a 3D saliency map, where the value of r(w,d,h) represents a likelihood of action clip x happening in 3D spatial location (w,d,h). The action region r thereby defines a proper probabilistic distribution in 3D space. The action region r may further be used to select interesting features with element-wise weighted pooling (e.g., indicated by reference numeral 318). Finally, both selectively aggregated 3D environment feature (e.g., indicated by reference numeral 320) and spatial-temporal video feature (e.g., indicated by reference numeral 312) may be jointly considered for action recognition and/or action label classification 322 discussed herein. Each of these operations and/or components is discussed in further detail below.

In one embodiment, the interaction may begin, at block 300, with the mapping server 200 receiving a user intent from the artificial reality system 100. For instance, the communication module 202 of the mapping server 200 may receive the user intent identified by the user intent identifier 110 of the artificial reality system 100. Based on the user's intent/context, the mapping server 200 may retrieve a corresponding map 302 from the data store 208, where the 3D maps 210 are stored. Also, the mapping server 200 may use a knowledge graph 212 to identify a list of items/objects that are relevant to the user's intent. For example, for the user context of watching tv in a living room, the knowledge graph 212 may identify a tv remote 302a, a coffee table 302b, a couch 302c, cushions 302d, etc. as the relevant list of items usually found in a living room, as shown in the map 302. As another example, for the cake baking context, the knowledge graph 212 may identify most-used ingredients/items used in cake baking, such as a baking sheet, a pan, a microwave, eggs, etc. as the relevant list of items for the user's intent of baking a cake. Using the knowledge graph 212 to identify the relevant list of items is advantageous as it helps the server 200 to reduce or trim down the action space (e.g., possible set of actions in the user's physical environment). In some embodiments, an annotated 3D semantic environment mesh e (e.g., map 302) may be known as prior. The 3D environment prior e may be available at both training and inference time.

The mapping server 200 uses the relevant list of items (e.g., items 302a-302d), identified using the knowledge graph 212, to filter out other objects/items from the environment and indexes the locations of these identified items in a compressed representation of the 3D environment. The compressed representation so generated may be a parent voxel representation 304. In particular embodiments, the parent voxel 304 is a high-level representation of the user's physical environment based on the user's intent, location, and time. Within the parent voxel 304, there may be a plurality of children voxels 306, where grids of each children voxel may indicate a rough/coarse location (not precise x,y,z location) or feature(s) of a particular item of the list of relevant items. By way of an example, the white grids 306a may represent a rough/coarse location or features of the tv remote 302a, the light gray grids 306b may represent a rough/coarse location or features of the coffee table 302b, the dark gray grids 306c may represent a rough/coarse location or features of the couch 302c, and the black grids 306d may represent a rough/coarse location or features of the cushions 302d.

In particular embodiments, an entire environment mesh (e.g., map 302) may be divided into X×Y×Z parent voxels. Each parent voxel may correspond to an action region notion and may be divided into multiple children voxels at a fixed resolution M. A semantic label may further be assigned to each parent voxel using the semantic mesh annotation. A semantic label of each child voxel may be determined by the majority vote of vertices that lie inside that child voxel. Therefore, the parent voxel is a semantic occupancy map that encodes both the 3D spatial structure information and semantic meaning of the environment. In particular embodiments, the parent voxel may store information of the afforded action distribution (e.g., a likelihood of each action happening in the parent voxel) and each children voxel may capture the occupancy and semantic information of surrounding environment. Note that a high resolution M will be able to approximate the real 3D mesh of the environment. Then the environment prior e is given as a 4D tensor, with dimension X x Y x Z x M³. The resulting parent-children semantic occupancy map is thus a more compact representation that considers the action region candidates, 3D spatial structure information and semantic meaning of the scanned environment in one-shot. The mapping server 200 may send the parent voxel 304 comprising the plurality of children voxels 306 (also interchangeably referred to herein as a parent-children semantic occupancy map) to the artificial reality system 100 for action region detection and action label classification, as shown and discussed below.

Block 301 on the right shows operations that are performed at the client side (i.e., by the artificial reality system 100) to detect an appropriate action region and accordingly generate one or more action labels 322 for performing one or more action direction tasks. Specifically, the operations shown and discussed in the block 301 enable the artificial reality system 100 to jointly predict an action category and localize an action region in the 3D environment. In particular embodiments, there are at least two sets of operations 307, 309 that run in parallel on the artificial reality system 100 in order to generate the action labels 322 discussed herein. The first set of operations 307 (e.g., upper portion of block 301) may be based on the parent-children semantic occupancy map 304 that is received from the mapping server 200. The second set of operations 309 (e.g., lower portion of block 301) may be based on a set of video frames 308 captured by the cameras 105A-105B of the artificial-reality system 100. In particular embodiments, the set of video frames 308 may be an input egocentric video denoted as x=(x¹, . . . , x^{t}) with its frames x^{t} indexed by time t. It should be noted that the invention is not limited to just the video frames 308 and other forms of data (e.g., audio data, data based on inertial sensors, etc.) from the artificial reality system 100 are also possible and within the scope of the present disclosure.

The first set of operations 307 may begin by the feature map generator 112 generating a first feature map 310 from the parent voxel 304 using a 3D convolution network. For instance, the feature map generator 112 may take environment prior e as input and uses 3D convolutional network to extract global 3D spatial environment feature 310. The second set of operations 309 may begin by the feature map generator 112 generating a second feature map 312 from the set of video frames 309 using the 3D convolution network. For instance, the feature map generator 112 may take video x as input, and utilizes 3D convolutional network to extract spatial-temporal video feature 312. Next, the two feature maps 310 and 312 may be processed by the action region generator 114 to generate an action region map 316. For instance, the action region generator 114 may concatenate the first feature map 310 (e.g., global environment feature) with the second feature map 312 (e.g., video feature) into a single map 314, which may further be processed by a machine-learning model 120, to generate an action region r, such as the action region map 316. The action region r may further be used to select interesting environment features with element-wise weighted pooling, as discussed elsewhere herein. In particular embodiments, the action region map 316 is a heat map that may indicate probabilities of where actions are likely to happen or take place within the user's current environment. For example, the heat map 316 may highlight specific portions/grids indicating coarse locations of items that are relevant to the user's intent. In particular embodiments, an action region r may be parameterized as a 3D saliency map, where the value of r(w,d,h) represents a likelihood of action clip x happening in 3D location (w,d,h). The action region r thereby defines a proper probabilistic distribution in 3D space. In some embodiments, the action region r may be modeled as a conditional probability p(y|x,e) by:

p(y|x,e)=∫ᵣp(y|r,x,e)p(r|x,e)dr. (1)

Specifically, p(r|x,e) models the action region r from video input x (e.g., video frames 308) and environment prior e (e.g., parent-children semantic occupancy map 304). p(y|r,x,e) further utilizes r to select region of interest (ROI) from environment prior e, and combines selected environment feature with video feature from x for action classification, as discussed in further detail below.

p(r|x,e) in equation (1) above is a key component that is used during action recognition. p(r|x,e) represents a conditional probability for action region grounding. Given a video pathway network feature ϕ(x) (e.g., indicated by reference numeral 312) and an environment pathway network feature ψ(e) (e.g., indicated by reference numeral 310), the action region generator 114 may use a mapping function to generate an action region distribution r. The mapping function may be composed of 3D convolution operation with parameters wᵣ and softmax function. Thus, p(r|x,e) is given by:

p(r|x,e)=softmax(wᵣ^{T}(ϕ(x)⊕ψ(e))) (2)

Where ⊕ denotes the concatenation along the channel dimension. Therefore, the resulting action region r is a proper probabilistic distribution normalized in 3D space, with r(w,d,h) reflecting the possibility of video x happening in the spatial location (w,d,h) of the 3D environment. In some embodiments, the action region generator 114 may receive additional action region prior q(r|x,e) as supervisory signals. q(r|x,e) may be derived from relocalizing 2D video frame into 3D scanned environment. Since 2D to 3D registration is fundamentally ambiguous, large uncertainty lies in the action region prior q(r|x,e). To account for this noisy pattern of q(r|x,e), stochastic units may be adopted. Specially, Gumbel-Softmax and reparameterization trick may be used to design a differentiable sampling mechanism:

$${\tilde{r}}_{w , d , h} ∼ \frac{exp ( ( log {r}_{w , d , h} + {G}_{w , d , h} ) / θ )}{{\sum }_{w , d , h} exp ( ( log {r}_{w , d , h} + {G}_{w , d , h} ) / θ )} , \qquad ( 3 )$$

Where G is a Gumbel distribution for sampling from a discrete distribution. This Gumbel-Softmax trick produces a “soft” sample that allows the gradients propagation to video pathway network ϕ and environment pathway network ψ, Θ is the temperature parameter that controls the shape of the soft sample distribution.

Once the action region map 316 is generated, the attention pooler 116 may use the action region map 316 to filter the first feature map 310 in order to generate a filtered first feature map 320 (also referred to interchangeably as an aggregated environment feature) of the user's environment via an attention pooling process 318 for use in action recognition. Specifically, the attention pooler 116 uses the sampled action location r for selectively aggregating environment feature (e.g., indicated by reference numeral 320). At a high level, the purpose of the attention pooling process 318 is to instruct the system where to pay more attention to. For example, if a user is going to be watching tv in his living room, then pay more attention to specific locations or items (e.g., location of tv remote) in the living room.

Finally, the artificial reality system 100 may use the final environmental embedding or the aggregated environment feature 320 and the spatial-temporal video feature 312 for the action recognition and to accordingly generate action labels 322 for display to the user. For instance, the action label classifier 118 may simultaneously process (e.g., concatenate) the filtered first feature map 320 resulting from the processing of the parent voxel 304 and the second feature map 312 resulting from the processing of the set of frames 308 to generate the action labels 322. In particular embodiments, the action label classifier 118 may calculate a probability p(y|r,x,e) with a mapping function ƒ( [symbol] ,x,e) that jointly considers action region r and video input x and environment prior e for action recognition. Formally, the conditional probability p(y|r,x,e) can be modeled as:

$$\begin{matrix}p ( y \vert r , x , e ) = f ( \tilde{r} , x , e ) \\ = softmax ( {w}_{p}^{T} \sum ( ϕ ( x ) ⊕ ( \tilde{r} ⊗ ψ ( e ) ) ) )\end{matrix} \qquad ( 4 )$$

Where ⊕ denotes the concatenation along feature channel, and ⊗ denotes the Hadamard product (element-wise multiplication), as discussed above in reference to attention pooling process 318. Σ is the average pooling operation that maps 3D feature to 2D feature, and wₚ is parameters of the linear classifier that maps feature vector to prediction logits. The sampled action region r in Hadamard product is used to model the uncertainty of the prior distribution of action region.

In particular embodiments, the action labels 322 generated based on the action recognition may be overlaid on a user's display screen. By way of an example, if the user intent is to bake a cake wearing their augmented reality (AR) glasses, then the action labels may include specific directions or steps to bake the cake, such as step 1) prepare baking pans, 2) preheat the oven to a specific temperature, 3) combine butter and sugar, 4) adds eggs one at a time, etc. As another example, if the user intent is watching tv that may be known through user saying “Hey, please turn on the TV”, then based on this intent, the AR glass would provide an action label like showing location of the TV remote on the user's glass display. In particular embodiments, the action label classifier 118 may perform its action label classification task using a trained machine-learning model 120.

During training of the machine-learning model(s) 120 for action recognition and action label classification, it is assumed that the prior distribution q(r|x,e) is given as supervisory signal. q(r|x,e) may be derived from registering 2D image in 3D environment scan. p(r|x,e) may be considered as latent variables and the deep latent variable model has the following loss function:

$$ℒ = - {\sum }_{r} log p ( y \vert r , x , e ) + KL [ p ( r \vert x , e ) \vert \vert q ( r \vert x , e ) ] \qquad ( 5 )$$

Where the first term is the standard cross entropy loss and the second term is the KL-divergence that matches the action region prediction to the prior distribution. Multiple action region samples r of the same inputs x, e will be drawn at different iterations for action recognition during training. Therefore, the action location r may also be sampled from the same input multiple times and average of the prediction may be taken at inference time. To avoid dense sampling at inference time, the deterministic action region r may be directly plugged into the equation (4) above.

FIG. 4A illustrates an example physical environment 402 viewable by a user 404 through an artificial reality system 100 (also interchangeably herein referred to as an augmented reality glass 100) and an example user intent 406 received by a mapping server 200 from the artificial reality system 100, in accordance with particular embodiments. As depicted, the physical environment 402 includes a view of a portion of the user's apartment or home. The portion includes living room 408, dining area 410, and kitchen 412. The physical environment 402 is viewable through the artificial reality system 100. For instance, the artificial reality system 100 may be an augmented reality (AR) glass worn by the user and the physical environment 402 is directly viewable to the user through the AR glass from a user's current perspective or viewpoint. While looking at the physical environment 402 through the AR glass, the user may provide a user intent or context 406 via an explicit voice command “I want to bake a cake”. The voice command may be captured by sensors, such as a voice sensor, of the artificial reality system 100. The user intent or context 406 may then be provided to the mapping server 200 for further processing, as discussed herein and in further detail below in reference to FIG. 4B. Although not shown, in some embodiments, user's current location, time of day, and user's history/preferences may also be shared along with the user intent/context 406 with the mapping server 200.

FIG. 4B illustrates an example parent-children semantic occupancy map 420 of a filtered physical environment 402a produced by the mapping server 200 based on the user intent 406, in accordance with particular embodiments. The filtered physical environment 402a may be a portion or part of the original physical environment 402 as shown in FIG. 4A. For instance, upon receiving the user intent or context 406, the mapping server 200 may identify a set of items that are relevant to the user's intent 406 in the physical environment 200. By way of an example and without limitation, the mapping server 200 may use a scene or a knowledge graph 212 to identify eggs, milk, sugar, oven, chocolate powder, baking pan, baking sheet, mixing bowl, utensils, etc. as some of the items that are relevant or associated with the cake baking context. Since all the identified set of items are commonly found or located in kitchen, the mapping server 200 may filter out the living room 408 and dining area 410 from a map of the physical environment 402 to generate a map of the filtered physical environment 402a including only the kitchen portion 412.

Upon filtering and identifying the relevant set of items associated with the user intent 406, the mapping server 200 may index the locations of the identified items in a compressed representation of the 3D environment, such as a voxel format 420. The voxel format 420 may be a high-level representation of the map of the filtered physical environment 402a. In particular embodiments, the voxel format 420 is a parent voxel that includes a plurality of children voxels 422. Each of the children voxels may be made up of a set of grids/vertices that indicate a rough/coarse location or feature(s) of an item of the identified set of items. For example, the light gray grids 422a represent a rough/coarse location or feature(s) of a mixing bowl, dark gray grids 422b represent a rough/coarse location or feature(s) of an oven, and black grids 422c represent a rough/coarse location or feature(s) of cake ingredients (e.g., milk, sugar, chocolate powder, flour, butter, etc.). The high-level compressed map representation of the 3D environment or parent voxel 420 may be sent to the artificial reality system 100 (e.g., AR glass) for action region detection (as discussed below in reference to FIG. 4C) and then action label classification (as discussed below in reference to FIGS. 4D-4E).

FIG. 4C illustrates an example action region detection operation by the artificial reality system 100 based on the compressed representation 420 received from the mapping server in FIG. 4B, in accordance with particular embodiments. Upon receiving the compressed representation 420 (e.g., parent-children semantic occupancy map), the computer 108 of the artificial-reality system may generate an action region map 430. For instance, as discussed above with respect to FIG. 3, the feature map generator 112 may generate feature maps corresponding to the parent-children semantic occupancy map 420 and video frame(s) of the user's current physical environment, and the action region generator 114 may then use these feature maps to generate the action region map 430. The action region map 430, as discussed elsewhere herein, may be a heat map that highlights or indicates regions/locations in the user's current physical environment (e.g., filtered physical environment 402a) where actions are likely to happen. By way of an example, the action region map 430 may indicate that actions corresponding to the user's cake baking context 406 are likely to happen in an action region 432 in the kitchen 412. The action region 432, as shown, includes all the necessary items that are needed to bake a cake. These items may be identified based on the relevant set of items identified by the mapping server 200 and stored in the parent-children semantic occupancy map 420.

FIGS. 4D-4E illustrate example actions labels 440 and 442 provided by the artificial reality system 100 for performing a task (e.g., an action direction task) based on the action region 432 detected in FIG. 4C, in accordance with particular embodiments. In particular, FIG. 4D illustrates a first example of an action label 440 that may be provided to a user with respect to the user's cake baking intent/context 406. The action label 440, in this example, shows step 3 that is involved in the cake baking process. FIG. 4E illustrates a second example of an action label 442 that may be provided to the user with respect to the user's cake baking intent/context 406. The action label 442, in this example, shows step 4 that is involved in the cake baking process. Both of these action labels 440 and 442 may be displayed on a display screen of the artificial reality 100 or the AR glass. For example, while the user is looking down at the mixing bowl in the action region 432 (e.g., see FIG. 4C), the action label 440 may be overlaid on the user's display screen directing the user to add milk, butter, and vanilla, and stir until well mixed. Once the step associated with action label 440 is completed, next action label 442 may be overlaid on the user's display screen now directing the user to beat in eggs and then add the beaten eggs to the mixture. In this way, the action labels 440 and 442 may help the user to perform the one or more action direction tasks, which in this case is to make the cake by following a set of steps. In particular embodiments, the action labels 440 and 442 may be generated and displayed by the action label classifier 118, as discussed elsewhere herein.

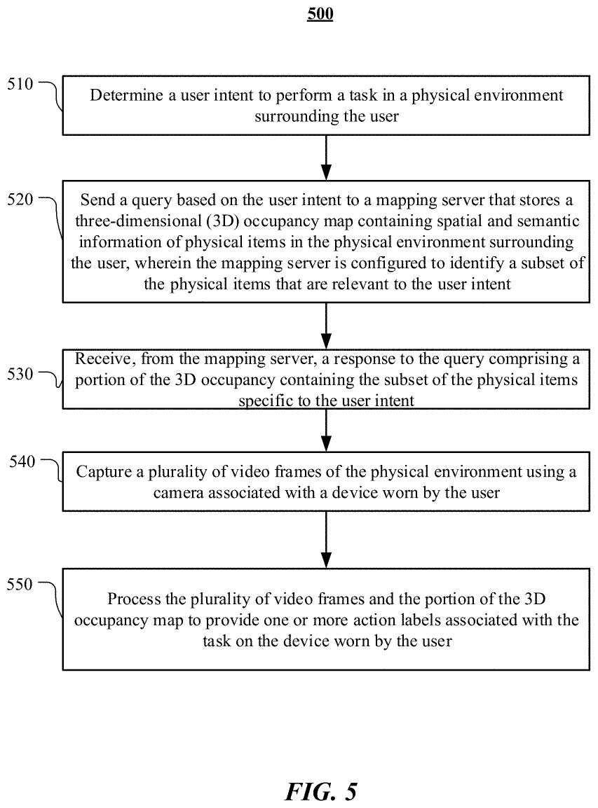

FIG. 5 illustrates an example method 500 for providing one or more action labels associated with a task, in accordance with particular embodiments. The method may begin at step 510, where a computing system (e.g., the computer 108) associated with an artificial reality device (e.g., the artificial reality system0 100) may determine a user intent to perform a task in a physical environment surrounding the user. For instance, the user intent identifier 110 of the artificial reality system 100 may determine the user intent, as discussed elsewhere herein. In one embodiment, the user intent identifier 110 may determine the user intent based on an explicit voice command of the user received by one or more sensors of the artificial reality system 100. In other embodiments, the user intent identifier 110 may determine the user intent automatically, without explicit user input, based on one or more a current location, a time of day, or previous history of the user, as discussed elsewhere herein. It should be understood that the present disclosure is not limited to just these two ways of user intent identification and other ways are also possible and within the scope of the present disclosure.

At step 520, the system (e.g., the computer 108 of the artificial reality system 100) may send a query based on the user intent to a mapping server (e.g., the mapping server 200), as shown and discussed for example in reference to FIG. 4A. The mapping server 200 stores a three-dimensional (3D) occupancy map containing spatial and semantic information of physical items in the physical environment surrounding the user. In some embodiments, the 3D occupancy map is a high-resolution global map (e.g., 3D map 210) of the physical environment surrounding the user. Upon receiving the user intent, the mapping server 200 may identify a subset of the physical items that are relevant to the user intent. In one embodiment, a knowledge graph 212 (also referred to as a scene graph) may be used by the mapping server 200 to identify the subset of the physical items. By way of an example, if the user intent is to bake a cake, the mapping server 200 may identify eggs, milk, sugar, oven, baking sheet, pan, etc. as most relevant items that are needed to bake a cake from a list of items present in the kitchen.

Based on the identified list of items, the mapping server 200 may filter the map of the user's physical environment. For instance, the map filter 205 of the mapping server 200 may filter out the objects/items in the user's physical environment that are not relevant to the user intent to generate a portion of the 3D occupancy map. Next, the map filter 205 may send the filtered map or the portion of the 3D occupancy map to the map compressor 206. The map compressor 206 may compress the portion of the 3D occupancy map into a voxel representation or format (e.g., voxel format 304 as shown in FIG. 3) and index locations of the identified subset of the physical items in it. For instance, the map compressor 206 may generate a parent-children semantic occupancy map that includes a parent voxel and a plurality of children voxels discussed herein. Each of the children voxels may be comprised of a set of grids that indicate a rough/coarse location or feature(s) of an item of the subset of the physical items specific to the user intent.

At step 530, the system (e.g., the computer 108 of the artificial reality system 100) in response to its query may receive the portion of the 3D occupancy map (e.g., parent-children semantic occupancy map) from the mapping server 200. At step 540, the system may capture a plurality of video frames that are associated with the current physical environment surrounding the user. For instance, cameras 105A-B of the artificial reality system 100 may capture one or more image/video frames based on the user's current viewpoint. For example, if the user is in the kitchen looking at the microwave or oven, then a video feed of that may be recorded by the cameras 105A-B of the HMD 104.

At step 550, the artificial reality system 100 may process the plurality of video frames and the portion of the 3D occupancy map in parallel to provide one or more action labels associated with the task for display on the device worn by the user, such as the HMD 104. This processing may include a number of steps performed by one or more components 112, 114, 116, 118, or 120 of the computer 108 of the artificial reality system 100, as shown and discussed in reference to at least FIGS. 1B and 3. For instance, as a first step of this processing, the feature map generator 112 may generate a first feature map (e.g., feature map 310) corresponding to the portion of the 3D occupancy map received from the mapping server 200 and a second feature map (e.g., feature map 312) corresponding to the plurality of video frames captured using camera(s) 105A-B of the artificial reality system 100. Next, the action region generator 114 may process (e.g., concatenate) the first and second feature maps and generate an action region map (e.g., action region map 316), as shown and discussed in reference to FIG. 3. In some embodiments, the action region map may be a heat map that highlights locations or indicate probabilities of where action is likely to happen. In some embodiments, the action region generator 114 may use a machine-learning model (e.g., machine-learning model 120) to generate the action region or heat map, as discussed elsewhere herein.

Once the action region map is generated, the attention pooler 116 may use the action region map to filter the first feature map (e.g., feature map 310) in order to generate a filtered first feature map (e.g., filtered feature map 320) via attention pooling. Finally, the action label classifier 118 may use the filtered first feature map and the second feature map to generate one or more action labels (e.g., action labels 322). In some embodiments, the action label classifier may use a trained machine-learning model (e.g., machine-learning model 120) to generate the one or more action labels associated with the task received from the user in step 510. In particular embodiments, the task may be an action direction task and the one or more action labels may aid in performing the action direction task. By way of a non-limiting example, if the user intent is to bake a cake, the one or more action labels may include steps that are needed to bake the cake, as shown for example in FIGS. 4D-4E. In some embodiments, the action labels are personalized for each user. For instance, in the cake baking example, action labels including steps to bake the cake for a first user may be different from steps generated for a second user. The action labels may be personalized based on a user's preference, history, etc. For instance, the first user may like to bake the cake in a way that is different from the second user and the action label classifier 118 may provide the action labels accordingly. In particular embodiments, the action label classifier 118 may use a trained machine-learning model 120 to do this personalization. For instance, the ML model(s) 120 running on the artificial reality system 100 of a user may be learned or trained to provide action labels as per the user's historical data (e.g., user baking a cake in a particular way), user-specific intent/context, location, and time. The action label classifier 118 may overlay the one or more action labels on a display screen of the artificial reality system 100.

Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for providing one or more action labels associated with a task, including the particular steps of the method of FIG. 5, this disclosure contemplates any suitable method for providing one or more action labels associated with a task, including any suitable steps, which may include a subset of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

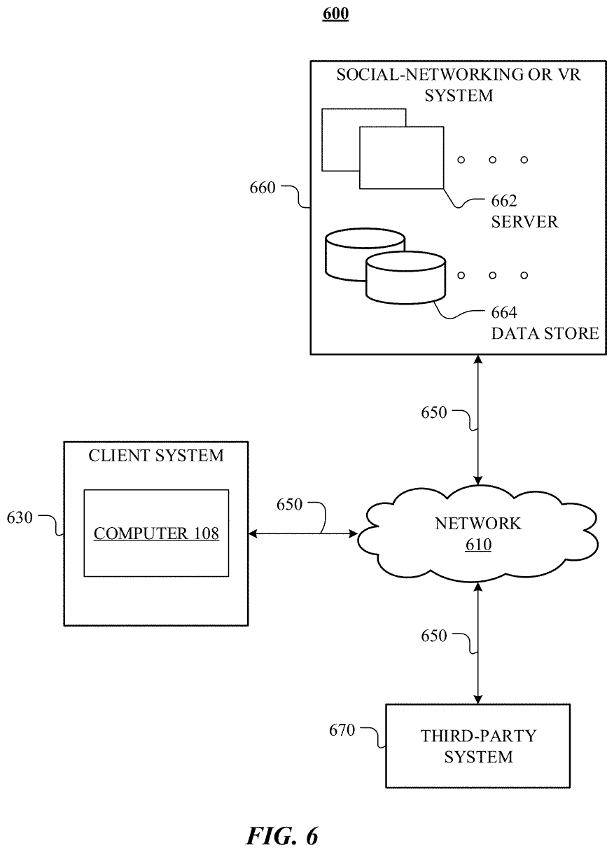

FIG. 6 illustrates an example network environment 600 associated with an AR/VR or social-networking system. Network environment 600 includes a client system 630 (e.g., the artificial reality system 100), a VR (or AR) or social-networking system 660 (including a mapping server 200), and a third-party system 670 connected to each other by a network 610. Although FIG. 6 illustrates a particular arrangement of client system 630, VR or social-networking system 660, third-party system 670, and network 610, this disclosure contemplates any suitable arrangement of client system 630, VR or social-networking system 660, third-party system 670, and network 610. As an example and not by way of limitation, two or more of client system 630, VR or social-networking system 660, and third-party system 670 may be connected to each other directly, bypassing network 610. As another example, two or more of client system 630, VR or social-networking system 660, and third-party system 670 may be physically or logically co-located with each other in whole or in part. Moreover, although FIG. 6 illustrates a particular number of client systems 630, VR or social-networking systems 660, third-party systems 670, and networks 610, this disclosure contemplates any suitable number of client systems 630, VR or social-networking systems 660, third-party systems 670, and networks 610. As an example and not by way of limitation, network environment 600 may include multiple client system 630, VR or social-networking systems 660, third-party systems 670, and networks 610.

This disclosure contemplates any suitable network 610. As an example and not by way of limitation, one or more portions of network 610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 610 may include one or more networks 610.

Links 650 may connect client system 630, social-networking system 660, and third-party system 670 to communication network 610 or to each other. This disclosure contemplates any suitable links 650. In particular embodiments, one or more links 650 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 650, or a combination of two or more such links 650. Links 650 need not necessarily be the same throughout network environment 600. One or more first links 650 may differ in one or more respects from one or more second links 650.

In particular embodiments, client system 630 may be an electronic device including hardware, software, or embedded logic components or a combination of two or more such components and capable of carrying out the appropriate functionalities implemented or supported by client system 630. As an example and not by way of limitation, a client system 630 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 630. A client system 630 may enable a network user at client system 630 to access network 610. A client system 630 may enable its user to communicate with other users at other client systems 630.

In particular embodiments, client system 630 (e.g., an artificial reality system 100) may include a computer 108 to perform the action region detection and action label classification operations described herein, and may have one or more add-ons, plug-ins, or other extensions. A user at client system 630 may connect to a particular server (such as server 662, mapping server 200, or a server associated with a third-party system 670). The server may accept the request and communicate with the client system 630.

In particular embodiments, VR or social-networking system 660 may be a network-addressable computing system that can host an online Virtual Reality environment or social network. VR or social-networking system 660 may generate, store, receive, and send social-networking data, such as, for example, user-profile data, concept-profile data, social-graph information, or other suitable data related to the online social network. Social-networking or VR system 660 may be accessed by the other components of network environment 600 either directly or via network 610. As an example and not by way of limitation, client system 630 may access social-networking or VR system 660 using a web browser, or a native application associated with social-networking or VR system 660 (e.g., a mobile social-networking application, a messaging application, another suitable application, or any combination thereof) either directly or via network 610. In particular embodiments, social-networking or VR system 660 may include one or more servers 662. Each server 662 may be a unitary server or a distributed server spanning multiple computers or multiple datacenters. In one embodiment, the server 662 is a mapping server 200 described herein. Servers 662 may be of various types, such as, for example and without limitation, a mapping server, web server, news server, mail server, message server, advertising server, file server, application server, exchange server, database server, proxy server, another server suitable for performing functions or processes described herein, or any combination thereof. In particular embodiments, each server 662 may include hardware, software, or embedded logic components or a combination of two or more such components for carrying out the appropriate functionalities implemented or supported by server 662. In particular embodiments, social-networking or VR system 660 may include one or more data stores 664. Data stores 664 may be used to store various types of information. In particular embodiments, a data store 664 may store 3D maps 210 and knowledge graph 212, as discussed in reference to FIG. 2. In particular embodiments, the information stored in data stores 664 may be organized according to specific data structures. In particular embodiments, each data store 664 may be a relational, columnar, correlation, or other suitable database. Although this disclosure describes or illustrates particular types of databases, this disclosure contemplates any suitable types of databases. Particular embodiments may provide interfaces that enable a client system 630, a social-networking or VR system 660, or a third-party system 670 to manage, retrieve, modify, add, or delete, the information stored in data store 664.

In particular embodiments, social-networking or VR system 660 may store one or more social graphs in one or more data stores 664. In particular embodiments, a social graph may include multiple nodes—which may include multiple user nodes (each corresponding to a particular user) or multiple concept nodes (each corresponding to a particular concept)—and multiple edges connecting the nodes. Social-networking or VR system 660 may provide users of the online social network the ability to communicate and interact with other users. In particular embodiments, users may join the online social network via social-networking or VR system 660 and then add connections (e.g., relationships) to a number of other users of social-networking or VR system 660 to whom they want to be connected. Herein, the term “friend” may refer to any other user of social-networking or VR system 660 with whom a user has formed a connection, association, or relationship via social-networking or VR system 660.

In particular embodiments, social-networking or VR system 660 may provide users with the ability to take actions on various types of items or objects, supported by social-networking or VR system 660. As an example and not by way of limitation, the items and objects may include groups or social networks to which users of social-networking or VR system 660 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking or VR system 660 or by an external system of third-party system 670, which is separate from social-networking or VR system 660 and coupled to social-networking or VR system 660 via a network 610.

In particular embodiments, social-networking or VR system 660 may be capable of linking a variety of entities. As an example and not by way of limitation, social-networking or VR system 660 may enable users to interact with each other as well as receive content from third-party systems 670 or other entities, or to allow users to interact with these entities through an application programming interfaces (API) or other communication channels.

In particular embodiments, a third-party system 670 may include one or more types of servers, one or more data stores, one or more interfaces, including but not limited to APIs, one or more web services, one or more content sources, one or more networks, or any other suitable components, e.g., that servers may communicate with. A third-party system 670 may be operated by a different entity from an entity operating social-networking or VR system 660. In particular embodiments, however, social-networking or VR system 660 and third-party systems 670 may operate in conjunction with each other to provide social-networking services to users of social-networking or VR system 660 or third-party systems 670. In this sense, social-networking or VR system 660 may provide a platform, or backbone, which other systems, such as third-party systems 670, may use to provide social-networking services and functionality to users across the Internet.

In particular embodiments, a third-party system 670 may include a third-party content object provider. A third-party content object provider may include one or more sources of content objects, which may be communicated to a client system 630. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking or VR system 660 also includes user-generated content objects, which may enhance a user's interactions with social-networking or VR system 660. User-generated content may include anything a user can add, upload, send, or “post” to social-networking or VR system 660. As an example and not by way of limitation, a user communicates posts to social-networking or VR system 660 from a client system 630. Posts may include data such as status updates or other textual data, location information, photos, videos, links, music or other similar data or media. Content may also be added to social-networking or VR system 660 by a third-party through a “communication channel,” such as a newsfeed or stream.

In particular embodiments, social-networking or VR system 660 may include a variety of servers, sub-systems, programs, modules, logs, and data stores. In particular embodiments, social-networking or VR system 660 may include one or more of the following: a web server, a mapping server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking or VR system 660 may also include suitable components such as network interfaces, security mechanisms, load balancers, failover servers, management-and-network-operations consoles, other suitable components, or any suitable combination thereof. In particular embodiments, social-networking or VR system 660 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking or VR system 660 to one or more client systems 630 or one or more third-party system 670 via network 610. The web server may include a mail server or other messaging functionality for receiving and routing messages between social-networking or VR system 660 and one or more client systems 630. An API-request server may allow a third-party system 670 to access information from social-networking or VR system 660 by calling one or more APIs. An action logger may be used to receive communications from a web server about a user's actions on or off social-networking or VR system 660. In conjunction with the action log, a third-party-content-object log may be maintained of user exposures to third-party-content objects. A notification controller may provide information regarding content objects to a client system 630. Information may be pushed to a client system 630 as notifications, or information may be pulled from client system 630 responsive to a request received from client system 630. Authorization servers may be used to enforce one or more privacy settings of the users of social-networking or VR system 660. A privacy setting of a user determines how particular information associated with a user can be shared. The authorization server may allow users to opt in to or opt out of having their actions logged by social-networking or VR system 660 or shared with other systems (e.g., third-party system 670), such as, for example, by setting appropriate privacy settings. Third-party-content-object stores may be used to store content objects received from third parties, such as a third-party system 670. Location stores may be used for storing location information received from client systems 630 associated with users. Advertisement-pricing modules may combine social information, the current time, location information, or other suitable information to provide relevant advertisements, in the form of notifications, to a user.

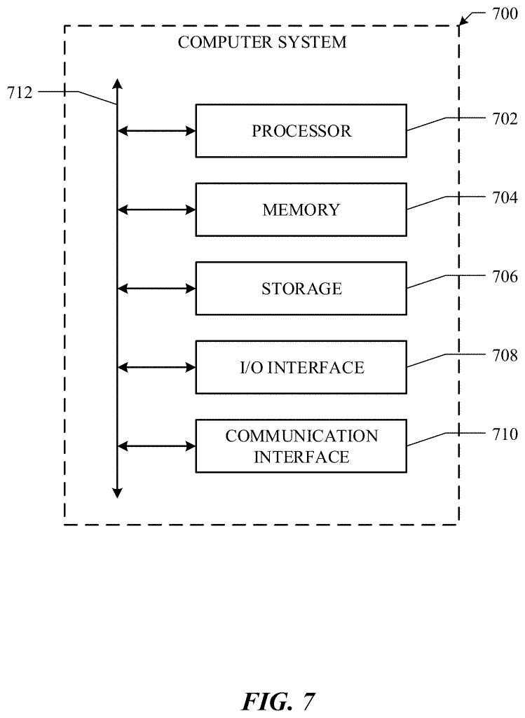

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
determining a user intent to perform a task in a physical environment surrounding the user;
sending a query based on the user intent to a mapping server that stores a three-dimensional (3D) occupancy map containing spatial and semantic information of physical items in the physical environment surrounding the user, wherein the mapping server is configured to identify a subset of the physical items that are relevant to the user intent;
receiving, from the mapping server, a response to the query comprising a portion of the 3D occupancy containing the subset of the physical items specific to the user intent;
capturing a plurality of video frames of the physical environment using a camera associated with a device worn by the user; and
processing the plurality of video frames and the portion of the 3D occupancy map to provide one or more action labels associated with the task on the device worn by the user.

2. The method of claim 1, wherein processing the plurality of video frames and the portion of the 3D occupancy map comprises:
generating a first feature map based on processing of the plurality of video frames;
generating a second feature map based on processing of the portion of the 3D occupancy map;
processing the first feature map and the second feature map to generate an action region map, the action region map indicating a probability of action happening within each region of the portion of the 3D occupancy map;
filtering, via an attention pooling process, the second feature map associated with the portion of the 3D occupancy map based on the action region map; and
using the first feature map associated with the plurality of video frames and the filtered second feature map associated with the portion of the 3D occupancy map to generate the one or more action labels for display on the device worn by the user.

3. The method of claim 2, wherein the first and second feature maps are generated using a three-dimensional (3D) convolution network.

4. The method of claim 2, wherein processing the first feature map and the second feature map to generate the action region map comprises:
concatenating the first feature map and the second feature map using a first machine-learning model.

5. The method of claim 4, wherein the one or more action labels are generated using a second machine-learning model.

6. The method of claim 2, wherein the action region map is a heat map.

7. The method of claim 1, wherein the portion of the 3D occupancy is a parent-children semantic occupancy map comprising a parent voxel and a plurality of children voxels.

8. The method of claim 7, wherein each children voxel of the plurality of children voxels comprises a plurality of grids indicating a coarse location or feature of an item of the subset of the physical items specific to the user intent.

9. The method of claim 1, wherein the subset of the physical items specific to the user intent is identified, at the mapping server, using a scene graph or a knowledge graph.

10. The method of claim 1, wherein:
the task is an action direction task; and
the one or more action labels aid in performing the action direction task.

11. The method of claim 1, wherein:
the device worn by the user is an augmented-reality device; and
the one or more action labels are overlaid on a display screen of the augmented-reality device.

12. The method of claim 1, wherein the plurality of video frames and the portion of the 3D occupancy map are processed in parallel.

13. The method of claim 1, wherein the user intent is determined explicitly through a voice command of the user.

14. The method of claim 1, wherein the user intent is determined automatically, without explicit user input, based on one or more of a current location, time of day, or previous history of the user.

15. One or more computer-readable non-transitory storage media embodying software that is operable when executed to:
determine a user intent to perform a task in a physical environment surrounding the user;
send a query based on the user intent to a mapping server that stores a three-dimensional (3D) occupancy map containing spatial and semantic information of physical items in the physical environment surrounding the user, wherein the mapping server is configured to identify a subset of the physical items that are relevant to the user intent;
receive, from the mapping server, a response to the query comprising a portion of the 3D occupancy containing the subset of the physical items specific to the user intent;
capture a plurality of video frames of the physical environment using a camera associated with a device worn by the user; and
process the plurality of video frames and the portion of the 3D occupancy map to provide one or more action labels associated with the task.

16. The media of claim 15, wherein to process the plurality of video frames and the portion of the 3D occupancy map, the software is further operable when executed to:
generate a first feature map based on processing of the plurality of video frames;
generate a second feature map based on processing of the portion of the 3D occupancy map;
process the first feature map and the second feature map to generate an action region map, the action region map indicating a probability of action happening within each region of the portion of the 3D occupancy map;
filter, via an attention pooling process, the second feature map associated with the portion of the 3D occupancy map based on the action region map; and
use the first feature map associated with the plurality of video frames and the filtered second feature map associated with the portion of the 3D occupancy map to generate the one or more action labels for display on the device worn by the user.

17. The media of claim 15, wherein:
the task is an action direction task; and
the one or more action labels aid in performing the action direction task.

18. A system comprising:
one or more processors; and
one or more computer-readable non-transitory storage media coupled to one or more of the processors and comprising instructions operable when executed by one or more of the processors to cause the system to:
determine a user intent to perform a task in a physical environment surrounding the user;
send a query based on the user intent to a mapping server that stores a three-dimensional (3D) occupancy map containing spatial and semantic information of physical items in the physical environment surrounding the user, wherein the mapping server is configured to identify a subset of the physical items that are relevant to the user intent;
receive, from the mapping server, a response to the query comprising a portion of the 3D occupancy containing the subset of the physical items specific to the user intent;
capture a plurality of video frames of the physical environment using a camera associated with a device worn by the user; and
process the plurality of video frames and the portion of the 3D occupancy map to provide one or more action labels associated with the task.

19. The system of claim 18, wherein to process the plurality of video frames and the portion of the 3D occupancy map, the one or more processors are further operable when executing the instructions to cause the system to:
generate a first feature map based on processing of the plurality of video frames;
generate a second feature map based on processing of the portion of the 3D occupancy map;
process the first feature map and the second feature map to generate an action region map, the action region map indicating a probability of action happening within each region of the portion of the 3D occupancy map;
filter, via an attention pooling process, the second feature map associated with the portion of the 3D occupancy map based on the action region map; and
use the first feature map associated with the plurality of video frames and the filtered second feature map associated with the portion of the 3D occupancy map to generate the one or more action labels for display on the device worn by the user.

20. The system of claim 18, wherein:
the task is an action direction task; and
the one or more action labels aid in performing the action direction task.
